(19) United States
(12) Patent Application Publication
(10) Pub. No.: US 2019/0001277 A1
(43) Pub. Date: Jan. 3, 2019

(54) METHOD AND APPARATUS FOR TREATING COMMERCIAL AND INDUSTRIAL LAUNDRY WASTEWATER

(71) Applicant: WATER RECOVERY SYSTEMS, LLC, Kenner, LA (US)

(72) Inventor: Kyle Anthony WOLFF, London (GB)

(73) Assignee: WATER RECOVERY SYSTEMS, LLC, Kenner, LA (US)

(21) Appl. No.: 15/997,395

(22) Filed: Jun. 4, 2018

Related U.S. Application Data
(60) Provisional application No. 62/514,828, filed on Jun. 3, 2017.
(60) Provisional application No. 62/514,834, filed on Jun. 3, 2017.

(51) Int. Cl. B01D 69/08; B01D 71/02; B01D 71/06; B01D 69/12; B01D 65/02; B01D 63/04; C02F 1/44

(52) U.S. Cl. CPC B01D 69/081; B01D 71/024; B01D 71/06; B01D 69/12; B01D 65/02; B01D 63/04; C02F 2101/308; B01D 2313/22; B01D 2317/04; B01D 2317/06; B01D 2321/12; B01D 2321/04; B01D 2317/025; C02F 1/44

(57) ABSTRACT

The present invention relates generally to an effluent treatment device including in one embodiment a skid configuration. The method and apparatus of the present invention can use only two fluid pump units and including individual or multiple membrane modules in a stacked longitudinally arranged configuration. The stacked or in series modules can be either vertical or horizontal forming a column. The membrane modules are contained in large diameter pipes with enough space around each module so that filtered permeate water collects in the pipe and backwash water can flow in the pipe to backwash the modules and contained membranes. The present invention includes one or more hollow fiber ceramic membrane modules which each includes multiple hollow fibers bundled together by end or band caps (e.g., ceramic, epoxy of glass material end caps) to form a complete membrane module. A complete hollow fiber membrane module can comprise multiple symmetric individual hollow fibers between about 2.0 to 4.00 millimeters inside diameter and can be made of aluminium oxide (Al₂O₃) substrate material. The geometry of the individual ceramic fiber walls can be between about 1.0 to 2.0 millimeters in thickness, known as the membrane wall. Such ceramic hollow fibers can have pores including a range of nominal 1 nanometer to 1400 nanometers. The ceramic hollow fibers can comprise selective membranes pores including a range of nominal 1 nanometer to 1400 nanometers which may include individual or multiple separating layers attached to the fiber walls of nominal 1 to 100 nanometers. The separating layers can each be a porous polymeric material. In one embodiment, a skid mounted treatment device is operable to pass water through an individual hollow fiber ceramic membrane module or multiple membrane modules in series known as a membrane loop. Filtration is inside to out flow filtration through the hollow fiber membranes. The apparatus is also operable to pass water through the hollow fiber ceramic filter module or multiple membrane modules in an outside to in flow direction, so as to remove material from the separation layer of the hollow fiber ceramic membrane fibers, a process known as backwashing or back flushing. Contaminant materials (retentate) having been deposited during inside-out filtration of the commercial or industrial laundry effluent is removed with such back flushing.

### CROSS-REFERENCE TO RELATED APPLICATIONS

This application claims benefit of U.S. Provisional Patent Application Ser. No. 62/514,828, filed 3 Jun. 2017; and U.S. Provisional Patent Application Ser. No. 62/514,834, filed 3 Jun. 2017, each of which is hereby incorporated herein by reference.

Priority of U.S. Provisional Patent Application Ser. No. 62/514,828, filed 3 Jun. 2017; and U.S. Provisional Patent Application Ser. No. 62/514,834, filed 3 Jun. 2017, each of which is hereby incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates generally to a laundry wastewater or waste fluid treatment device. Particular embodiments relate to a commercial and industrial laundry effluent treatment skid mounted device. The processing effluent from such application can be reused as clean water. The removal of contaminants is both organic and inorganic. This invention is uniquely designed to incorporate individual fiber ceramic membranes, bundled together (e.g., by epoxy, ceramic or glass endcaps) to form a membrane module.

### 2. General Background of the Invention

Commercial and industrial laundry operations generate quantities of wastewater that must be disposed of. Such laundry operations can employ large washing machines such as tunnel washing machines. U.S. Provisional Patent Application Ser. No. 62/514,834, filed 3 Jun. 2017, is hereby incorporated herein by reference. Several patents have issued for tunnel washing machines.

The following table lists examples of such patents, each patent listed in the table is hereby incorporated herein by reference:

| | | Issue Date |
|---|---|---|
| Pat. No. | Title | MM-DD-YYYY |
| 5,707,584 | METHOD FOR THE PRODUCTION OF CERAMIC | 01/13/1998 |
| | HOLLOW FIBRES | |
| 7,611,627 | MEMBRANE MODULE S WELL AS A METHOD | 11/03/2009 |
| | FOR MAKING A MEMBRANE MODULE | |
| 7,971,302 | INTEGRATED CONTINUOUS BATCH TUNNEL | 07/05/2011 |
| | WASHER | |
| 8,166,670 | CLOTHES DRYER APPARATUS WITH IMPROVED | 05/01/2012 |
| | LINT REMOVAL SYSTEM | |
| 8,336,144 | CONTINUOUS BATCH TUNNEL WASHER AND | 12/25/2012 |
| | METHOD | |
| 8,365,435 | LAUNDRY PRESS APPARATUS AND METHOD | 02/05/2013 |
| 8,370,981 | INTEGRATED CONTINUOUS BATCH TUNNEL | 02/12/2013 |
| | WASHER | |
| 8,689,463 | CLOTHES DRYER APPARATUS WITH IMPROVED | 04/08/2014 |
| | LINT REMOVAL SYSTEM | |
| 9,127,389 | CONTINUOUS BATCH TUNNEL WASHER AND | 09/08/2015 |
| | METHOD | |
| 9,200,398 | CONTINUOUS BATCH TUNNEL WASHER AND | 12/01/2015 |
| | METHOD | |
| 9,322,128 | LAUNDRY PRESS APPARATUS AND METHOD | 04/26/2016 |
| 9,580,854 | CONTINUOUS BATCH TUNNEL WASHER AND | 02/28/2017 |
| | METHOD | |

### BRIEF SUMMARY OF THE INVENTION

The present invention relates generally an effluent wastewater treatment apparatus including in one embodiment a skid configuration. The method and apparatus of the present invention can preferably use only two fluid pump units and including individual or multiple membrane modules in a stacked longitudinally arranged configuration. The stacked or in series modules can be either vertical or horizontal forming a column.

The present invention includes one or more hollow fiber ceramic membrane modules which each includes multiple hollow fibers bundled together preferably by end bands or caps (e.g., ceramic, epoxy of glass material end caps) to form a complete membrane module. A complete hollow fiber membrane module can comprise multiple symmetric individual hollow fibers, each between about 2.0 to 4.00 millimeters inside diameter and can be made of aluminium oxide (Al₂O₃) substrate material.

The geometry of the individual ceramic fiber walls can be between about 1.0 to 2.0 millimeters in thickness, known as the membrane wall. Such ceramic hollow fibers can have pores including a range of nominal 1 nanometer to 1400 nanometers. The ceramic hollow fiber membranes can comprise selective membranes pores including a range of nominal 1 nanometer to 1400 nanometers, which may include individual or multiple separating layers attached to the fiber walls of nominal 1 to 100 nanometers. The separating layers can each be a porous polymeric or porous ceramic material.

In one embodiment, a skid mounted treatment device is preferably operable to pass water through an individual hollow fiber ceramic membrane module or multiple membrane modules in series known as a membrane loop. For example, there can be eighteen (18) modules, three stacked columns of three modules each (or nine modules) on a left side and nine more on a right side. Filtration is preferably inside to out flow filtration through each of the hollow fiber membranes. The apparatus is also preferably operable to pass water through the hollow fiber ceramic filter module or multiple membrane modules in an outside to in backflow direction, so as to remove material from the separation layer of the hollow fiber ceramic membrane fibers, a process known as backwashing or back flushing. Contaminant materials (retentate) having been deposited during inside-out filtration of the commercial or industrial laundry effluent is preferably removed with such back flushing or washing.

The apparatus can include a heater or steam injector and diffuser, operable to heat laundry effluent wastewater to between about 50-80° C. to pass through the hollow fiber ceramic membrane module or membrane modules in series after such heating. This aspect provides a controlled and improved flux and yield of recycled water known as permeate and synergistically improved flux longevity and maintenance of the hollow fiber ceramic membrane modules, which provides further improvements in yield and throughput.

The apparatus can include a program logic controller or software or other controller or instrumentation operable to control the flow device to pass effluent through the hollow fiber ceramic membrane modules according to any selected or desired operating schedule. The controller may be operable to collect and read data defining a maintenance schedule for the skid mounted effluent treatment device.

The apparatus can include a forward-flow function, operable to provide the inside to out filtration process through the hollow fiber ceramic membrane wall.

The apparatus can include a reverse-flow function operable to provide outside to in flow through the hollow fiber ceramic membrane wall, for backwashing or back flushing.

The apparatus may include a membrane cleaning step operable to provide periodical chemical cleaning.

The apparatus may include an ancillary permeate or back wash tank that receives permeate water. This permeate water can provide water to the reverse-flow process or backwash part of the system.

The apparatus may include an inlet conduit operable to receive commercial or industrial laundry effluent wastewater to be filtered by passing through each hollow fiber ceramic membrane of the hollow fiber ceramic membrane modules in a forward direction.

The apparatus may include an inlet conduit operable to receive commercial or industrial laundry recycled fluid known as permeate (in addition to a clean water supply derived from local city sources) to be passed through the hollow fiber ceramic membrane module in a reverse direction, during back washing or back flushing.

The apparatus may include multiple hollow fiber membrane modules to operate individually or in series, stacked as multiple modules creating one or more vertical columns (for example, six stacks of three modules each or a total of eighteen modules).

The apparatus may include hollow fiber membrane modules to operate individually or in series, stacked in multiple preferably creating one horizontal column. The stacking of the membrane modules consisting of multiple hollow fiber membrane preferably provides a compact configuration and high filtration surface area which can reduce overall footprint of the apparatus. In one embodiment, a compact skid arrangement is preferably provided.

The apparatus may include conduits connected to the membrane module or multiple modules in series to channel effluent wastewater into the membrane module or multiple modules in series alternatively, as conduits right and left.

The apparatus may include a conduit connected to the membrane module or multiple modules in series to evenly channel effluent or fluid known as retentate to a selected retentate tank or flow line.

The apparatus may include a hollow fiber ceramic membrane module which preferably holds multiple hollow fibers bundled together by end bands or caps (e.g., ceramic material or epoxy material end bands or caps) to form a complete membrane module. A complete hollow fiber membrane module can comprise as an example multiple (e.g., 200-1500) nominal 2.0 to 4.0 millimeters inside diameter symmetric individual hollow fibers, made of ceramic (e.g., aluminium oxide (Al₂O₃)) substrate material. The geometry of the individual ceramic hollow fiber walls can be for example about 1 to 2 millimeters in thickness, known as the membrane wall. Such ceramic hollow fibers can comprise of selective membranes pores including a range of between about 1 nanometer to 1400 nanometers.

The apparatus may include a hollow fiber membrane module, which includes between about 200 and 1500 individual ceramic hollow fibers preferably made of a ceramic (e.g., aluminium oxide (Al₂O₃)) substrate material. The fiber geometry can be between about 2 to 4 millimeters inside diameter, between about 4.00 to 6.00 millimeters outside diameter, length between about 360 to 1000 millimeters, bundled together with either epoxy, ceramics or glass end caps to provide excellent thermal stability and a wide range of pH stability and the ability to operate at high operating temperature of between about 50 to 80 degrees centigrade.

The apparatus may include individual or multiple hollow fiber membrane modules which can include for example between about 200 to 1500 individual ceramic hollow fibers made of ceramic (for example of aluminium oxide (Al₂O₃)) substrate material. Pore sizes of the aluminium oxide substrate material (Al₂O₃) can be between about 50 to 1400 nanometers, also but not limited to selective pore sizes of the aluminium oxide substrate material (Al₂O₃) being nominal 50 to 1400 nanometers, including nominal 1 to 100 nanometers porous ceramic or polymeric coating or multiple separate ceramic porous polymeric coatings, acting as a separating layer attached to the membrane fiber wall. The polymeric coating can be of any porous polymeric material. In one embodiment, each hollow ceramic fiber can have a polymeric or metal oxide or graphene oxide coating on the tube wall. The metal oxide can preferably be, for example, aluminium oxide, zirconia oxide or titanium oxide.

The compact hollow fiber membrane module preferably with selective membrane pores including a range of about 1 to 1400 nanometers separates undesirable matters in the industrial commercial laundry effluent such as and not limited to fine suspended particulates, microbes, bacteria and viruses, coloring matter, colloidal matter and dissolved solids and producing clean permeate for reuse in the laundering process.

One embodiment of the present invention relates to a water treatment apparatus that provides a hollow fiber ceramic membrane module preferably operable to filter effluent passed through one or more of the hollow fiber ceramic membrane modules. A heater or steam injector and diffuser preferably heats the fluid to be filtered by the hollow fiber ceramic membrane module. The apparatus may include a heater or steam injector and diffuser to heat effluent to be passed through the hollow fiber ceramic membrane module in a forward direction. The heater may be used to heat the effluent to about 40 degrees centigrade or more. The heater may be used to heat the water to about 50 degrees centigrade or more. The heater may be used to heat the effluent to within a temperature range of between about 50 to 80 degrees centigrade.

The apparatus may include a feed pump and a circulation pump. The apparatus may include a preliminary filter to filter effluent prior to it being passed through the hollow fiber ceramic membrane module, such as a vibrating mesh screen, to remove larger organic or inorganic material such as lint or fibers.

The apparatus may include multiple valves such as controlled actuated valves (e.g., solenoid actuated valves).

The apparatus may include a pH adjustment device operable to adjust the pH level of permeate water that is preferably discharged from the apparatus.

The apparatus may include a conductivity measuring and adjustment device, preferably operable to adjust the analyse and control the level of conductivity in the permeate monitor to the effluent quality.

The apparatus may include turbidity measuring, preferably operable to analyse the level of turbidity in the permeate water.

The method can include pumping commercial or industrial waste, firstly in a forward direction into a conduit such as “conduit right”, being a stainless steel pipe or header with a diameter of between about 100 to 250 millimeters. The “conduit right” pipe or header preferably transmits flow to the hollow fiber ceramic membrane module or modules in series, so as to enable the hollow fiber ceramic membrane to remove contaminants from the effluent using in to out cross flow, whilst forcing water know as permeate through the fiber wall.

The method may include pumping wastewater in a second forward direction, alternately, into conduit such as “conduit left”, also being a pipe or header with a diameter of between about 100 to 250 millimeters. Flow in the “conduit left” is preferably to the hollow fiber ceramic membrane module or modules in series, so as to preferably enable the hollow fiber ceramic membrane surface using “crossflow” to remove contaminants from the effluent, whilst forcing water know as permeate through each tube wall of the module.

The method of pumping through the inlets right conduit and left conduit may be carried out on an alternating cycles with a backwash in between such “left conduit” and “right conduit” filtration. The “left conduit” can include three (3) vertical columns of three modules each or nine modules total. The “right conduit” could also have nine modules. In one embodiment, filtration is preferably for a longer period of time than backwashing.

The disclosed method of pumping and distributing the contaminated fluid to the inlet conduits “right” or “left” may substantially improve the separation efficiency through every membrane loops with optimised cross-flow rate and lower operating pressure possible.

The method of the present invention may include pumping permeate water from a permeate storage tank into the inlet conduit, to conduits “right” and conduits “left”, preferably flushing the effluent treatment in a third direction with permeate water.

The method of the present invention may comprise pumping fluid such as permeate water from a permeate storage tank, into the inlet conduit in a reverse direction, to conduits connected to the hollow fiber ceramic membrane module or modules in series, dislodging contaminants by way of back washing or back flushing of the hollow fiber ceramic membrane fibers or module or modules in series, lodged on the hollow fiber ceramic membrane surface, during pumping effluent either in first or second directions.

The method of the present invention may include a short backwash timing of for example between about 10 to 60 seconds using permeate water with a tangential flow suited for the plurality of the membrane fibers and modules and thin membrane separating layer structure.

The method of the present invention advantageously helps preserve the efficiency of the membrane separating layers of the hollow fiber ceramic membrane modules and increase its resistance to fouling, preserving the service life of the membrane significantly and reducing the need for membrane chemical cleaning.

The membrane filtration water treatment process may operate on continuous basis, therefore preferably improving permeate recovery rate and preferably minimizing the loss of thermal energy in the commercial laundry effluent, thus preferably providing potential water and energy savings for the industrial commercial laundry application.

The method of the present invention may comprise multiple valves which can be operated preferably by controller, by computer, or program logic control or using control software as examples.

The method of the present invention may include heating wastewater effluent to be forced in the first and second forward directions (e.g., left conduit and right conduit). Some embodiments relate to a process to treat water including filtering water through a pre-filter such as a vibrating screen device and subsequently pumping the effluent through one or more hollow fiber ceramic membrane modules.

Some embodiments of the present invention optionally relate to a computer readable carrier medium, carrying computer executable code, the code operable when executed to configure a configurable device to control a water or effluent treatment device.

Some embodiments of the present invention relate to a computer system including a code memory preferably operable to store processor executable code; a processor preferably operable to execute code stored in the code memory; and a data memory preferably operable to store data; a cloud-based system preferably operable to collect and store data points from the programmable logic control or controls software from the effluent treatment device, wherein the code memory stores code, which when executed, preferably causes the computer to control an effluent treatment device to perform the method of one of the paragraphs above or causes the computer to configure a configurable device to control an effluent treatment device to perform the method of one of the paragraphs above. Some embodiments can use the computer system as part of a computer-controlled effluent treatment system configured to perform the functions various of the system.

The water treatment process of the present invention may not require carbon filtration downstream of the water treatment device.

The present invention includes a method of removing waste from a laundry wastewater stream, comprising the steps of:

a) heating the wastewater stream to a temperature of at least 40° Celsius;

b) transmitting the waste stream with piping to one or more modules, each module having multiple hollow ceramic fibers, each hollow ceramic fiber having a wall with an exterior and a bore;

c) filtering the waste stream to remove waste material from the waste stream by flowing the waste stream from the bore laterally through the wall to the exterior of the wall;

d) collecting a permeate fluid stream in step “c” of cleaned water that has passed through the walls of the hollow ceramic fibers;

e) after a time interval, backwashing each hollow ceramic fiber by flowing a backwash fluid from the exterior of the wall, through the wall and into the bore of each hollow ceramic fiber;

f) wherein in step “e” the backwash fluid is cleaner than the wastewater stream;

g) wherein in step “e”, a fluid stream flows longitudinally through the bore of each hollow ceramic fiber and simultaneously with backwashing to generate a retentate stream; and

h) transmitting the retentate stream to a collection vessel.

In one embodiment, the temperature can be between about 40-90 degrees Celsius.

In one embodiment, the backwash fluid can be permeate fluid that was collected in step “d”.

In one embodiment, the backwash fluid includes clean water.

In one embodiment, the wall of each hollow ceramic fiber can be between about 1 and 4 mm thick.

In one embodiment, the wall of each hollow ceramic fiber can be between about 2 and 4 mm thick.

In one embodiment, there can be multiple of the modules of hollow ceramic fibers.

In one embodiment, each hollow ceramic fiber has a separating layer with a pore size of between 1 and1400 nanometers.

In one embodiment, there can be between about 200 and 1500 of the hollow ceramic fibers in each module.

In one embodiment, the removed material in step “c” includes suspended and dissolved solids.

In one embodiment, the removed material in step “c” includes dye.

In one embodiment, the removed material in step “c” includes dissolved organics.

In one embodiment, the removed material in step “c” includes bacteria and viruses.

In one embodiment, the removed material in step “c” includes colloids.

In one embodiment, the multiple modules are stacked and aligned in series.

In one embodiment, the waste stream flows at a rate of between 10 and 500 gallons (38-1,893 liters) per minute.

In one embodiment, the permeate fluid stream can be transmitted to a washing machine after step “d” at a temperature of at least 35 degrees Celsius.

In one embodiment, each hollow ceramic fiber in step “b” can have an outside diameter of between about 4 and 6 mm.

In one embodiment, each hollow ceramic fiber in step “b” has a length of between about 300 and 1000 mm.

In one embodiment, in step “b” each hollow ceramic fiber includes a ceramic substrate with a pore size of between about 50 and 1400 nanometers.

In one embodiment, each hollow ceramic fiber has a polymeric or metal oxide or graphene oxide coating on the tube wall.

In one embodiment, the filtration of step “c” has a duration of between about 5 and 120 minutes.

In one embodiment, the backwashing of step “e” has a duration of between about 10 and 60 seconds.

In one embodiment, the invention further comprises venting the piping and module or modules to reduce the risk of trapped air before the filtration of step “c”.

In one embodiment, there are multiple loops of stacks of modules.

In one embodiment, the filtration of step “c” includes transmitting the waste stream through the modules in a first flow direction and after the backwashing of step “e” transmitting the waste stream through the modules in a second flow direction that is preferably opposite the first flow direction.

The present invention includes a laundry wastewater treatment apparatus comprising:

a) a piping system having an inflow for receiving the wastewater stream to be treated;

b) a heater for enabling heating of the wastewater stream to a temperature of at least 40° Celsius;

c) the piping including one or more modules, each module having multiple hollow ceramic fibers, each hollow ceramic fiber having a wall with an exterior and a bore;

d) one or more pumps that pump the wastewater stream to the module or modules and laterally through the wall to the exterior of the wall of each hollow ceramic fiber;

e) the piping system including a permeate fluid stream of cleaned water that has passed through the walls of the hollow ceramic fibers;

f) the piping system having valving that enables a backwashing each hollow ceramic fiber by flowing a backwash fluid with the pump or pumps from the exterior of the wall, through the wall and into the bore of each hollow ceramic fiber;

g) wherein the backwash fluid is cleaner than the wastewater stream;

h) wherein the pump or pumps transmit a fluid stream that flows longitudinally through the bore of each hollow ceramic fiber and simultaneously with backwashing to generate a retentate stream; and

i) a retentate stream collection vessel that receives retentate from the modules.

In one embodiment, the temperature of the wastewater stream is between about 40-90 degrees Celsius.

In one embodiment, backwash fluid is from the permeate fluid that was collected in step “d”.

In one embodiment, the backwash fluid includes clean water.

In one embodiment, the wall of each hollow ceramic fiber can be between about 2 and 4 mm thick.

In one embodiment, there are multiple of said modules of hollow ceramic fibers.

In one embodiment, each hollow ceramic fiber has a porous polymeric separating layer with a pore size of between 1 and1400 nanometers.

In one embodiment, there are between about 200 and 1500 of said hollow ceramic fibers in each said module.

In one embodiment, the retentate includes suspended and dissolved solids.

In one embodiment, the retentate includes dye.

In one embodiment, the retentate includes dissolved organics.

In one embodiment, the retentate includes bacteria and viruses.

In one embodiment, the retentate includes colloids.

In one embodiment, the multiple modules are stacked and aligned in series.

In one embodiment, the wastewater stream flows at a rate of between 10 and 500 gallons (38-1,893 liters) per minute.

In one embodiment, the invention further comprises a washing machine and wherein the permeate fluid stream flows to the washing machine with a flow line at a temperature of at least 35 degrees Celsius.

In one embodiment, each hollow ceramic fiber has an outside diameter of between about 4 and 6 mm.

In one embodiment, each hollow ceramic fiber has a length of between about 300 and 1000 mm.

In one embodiment, each hollow ceramic fiber includes a ceramic substrate with a pore size of between about 50 and 1400 nanometers.

In one embodiment, each hollow ceramic fiber has a porous polymeric coating on the hollow ceramic fiber wall.

In one embodiment, there are multiple loops of stacks of modules.

In one embodiment, the invention further comprises a skid or base and wherein all or part of the piping system is mounted on the skid or base.

In one embodiment, the invention further comprises a skid or base and wherein all or part of the pumps is mounted on the skid or base.

In one embodiment, the invention further comprises a skid or base and wherein all or part of the modules is mounted on the skid or base.

In one embodiment, the piping system includes permeate and retentate flow lines supported upon the skid or base.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a schematic diagram showing a method and apparatus of the present invention;

FIG. 2 is a schematic diagram of a method and apparatus of the present invention;

FIG. 3 is a schematic diagram of a method and apparatus of the present invention showing pumping to the left side conduit;.

FIG. 4 is a schematic diagram of a method and apparatus of the present invention showing a flushing of fluid in a forward direction;

FIG. 5 is a schematic diagram of a method and apparatus of the present invention showing the backwash step after filtration;

FIG. 6 is a schematic diagram of a method and apparatus of the apparatus of the present invention showing pumping of effluent into the right side conduit;

FIG. 7 is a schematic diagram of a method and apparatus of the present invention illustrating cleaning in place of membranes;

FIG. 8 is a schematic diagram of a method and apparatus of the present invention illustrating cleaning in place of membranes;

FIG. 9 is a fragmentary view illustrating a module that contains multiple hollow fiber ceramic membranes;

FIG. 10 is a fragmentary view illustrating a module that contains multiple hollow fiber ceramic membranes;

FIG. 11 is a fragmentary view illustrating a module that contains multiple hollow fiber ceramic membranes;

FIG. 12 is a fragmentary perspective view illustrating a single hollow fiber ceramic membrane;

FIG. 13 is fragmentary cross sectional view of a single hollow fiber ceramic membrane;

FIG. 14 is a partial perspective view that illustrates inside to out filtration during a normal operating mode for filtration;

FIG. 15 is a fragmentary perspective view of a hollow fiber ceramic membrane showing outside to in filtration during a backwash operating mode;

FIG. 16 is a partial plan view of a preferred embodiment of the apparatus of the present invention showing a skid mounted embodiment;

FIG. 17 is a perspective view of a preferred embodiment of the apparatus of the present invention showing a skid mounted embodiment;

FIG. 18 is a perspective view of a preferred embodiment of the apparatus of the present invention showing a skid mounted embodiment and with filtration treatment beginning with the right side conduit;

FIG. 19 is a perspective view of a preferred embodiment of the apparatus of the present invention showing a skid mounted embodiment and with filtration treatment beginning with the left side conduit;

FIG. 20 is a perspective view of a preferred embodiment of the apparatus of the present invention illustrating backwashing beginning with the left side conduit; and

FIG. 21 is a perspective view of a preferred embodiment of the apparatus of the present invention illustrating backwashing beginning with the right side conduit.

### DETAILED DESCRIPTION OF THE INVENTION

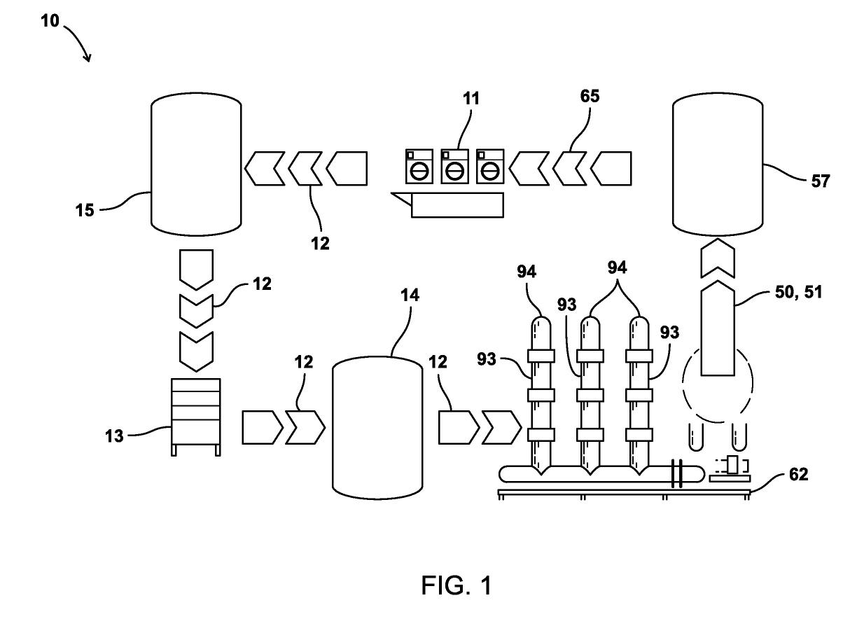

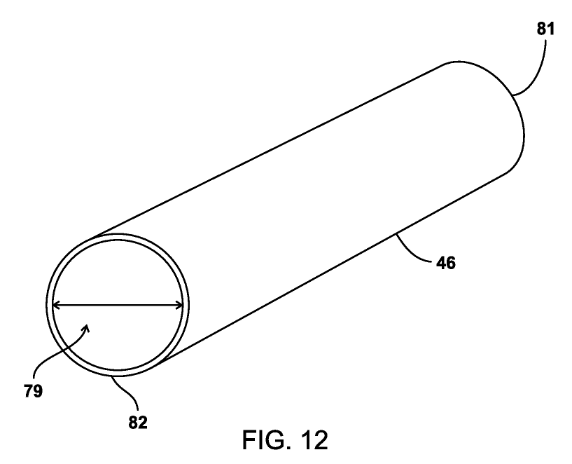

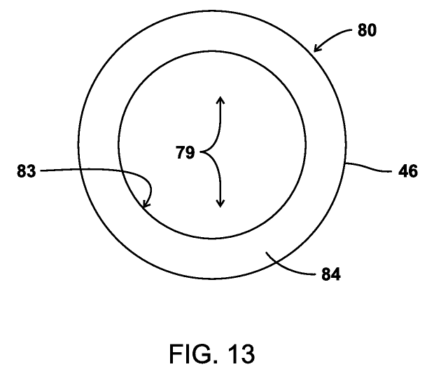

FIGS. 1-21 show a preferred embodiment of the apparatus of the present invention, designated generally by the numeral 10. In one embodiment, apparatus 10 can be in the form of a skid mounted treatment unit 62 preferably with pump, valve and piping components for ease of transport and to reduce footprint. Apparatus 10 in FIGS. 1-8 preferably has piping that routes an incoming wastewater stream 12 to pretreatment screen 13 (e.g., vibratory screen) and then feed tank 14. In FIGS. 1-8, wastewater stream 12 can be transmitted from commercial laundry 11 to an effluent sump 15 before cleaning at screen/pre-filter 13 to remove larger particles such as lint or fiber material. Flow line 16 has pump 18 for transfer of fluid from tank 15 to screen 13 and then via line 17 to tank 14.

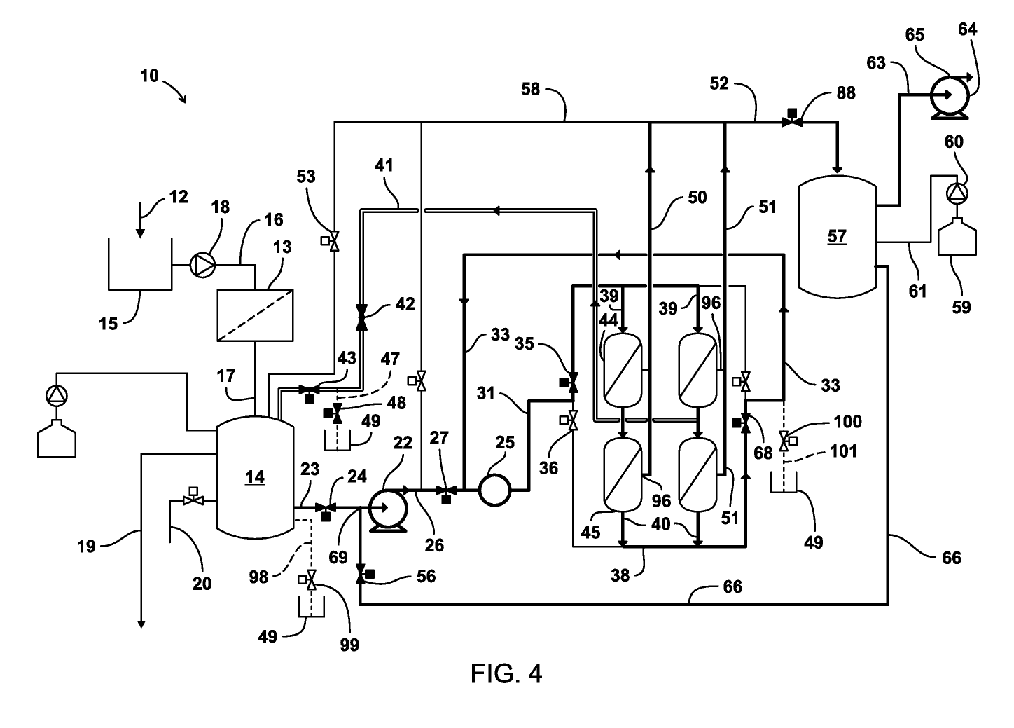

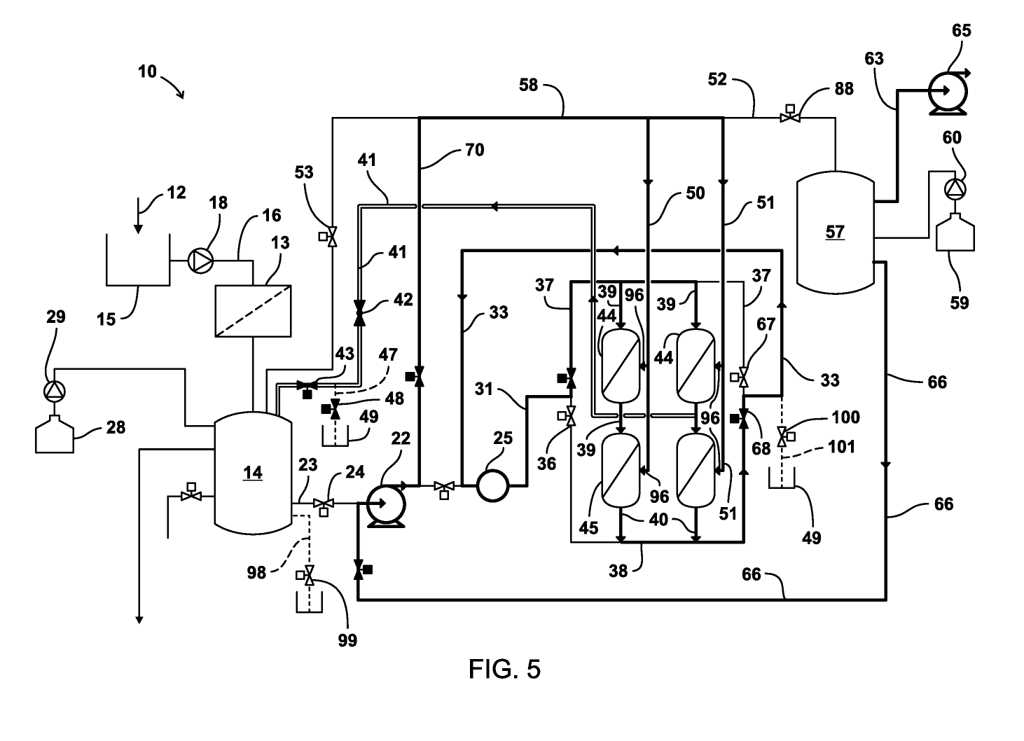

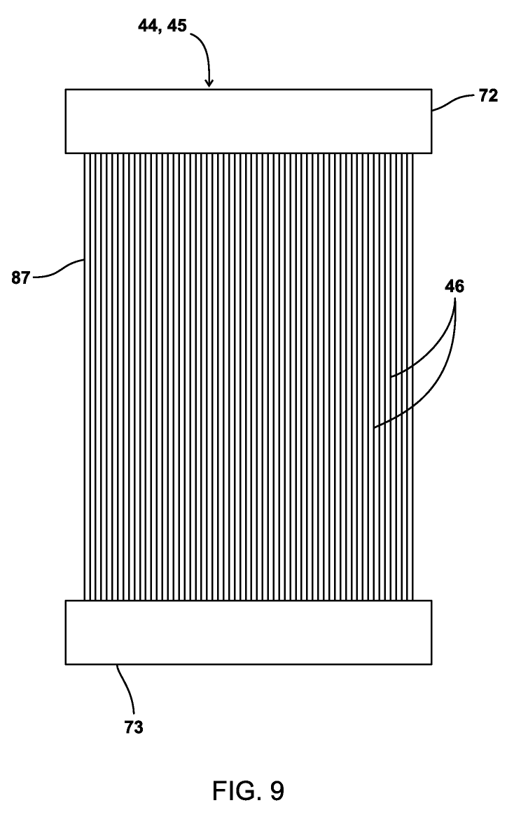

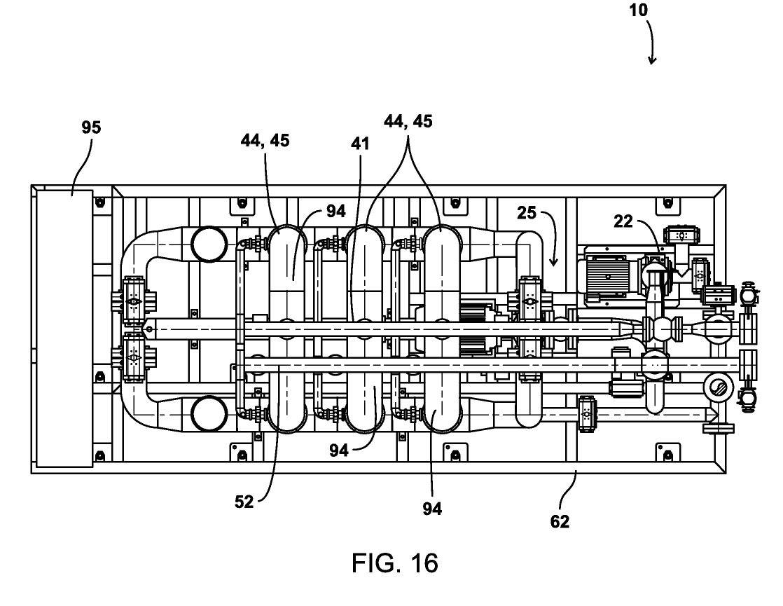

Feed tank or vessel 14 receives flow from sump 15 and screen 13 via flow lines 16, 17. Feed tank 14 transmits the wastewater stream 12 to the various pump, valve and treatment module components that can be skid mounted on skid or base or frame 62 (see FIGS. 16-21). Apparatus 10 has a piping system that includes a left conduit 39 and a right conduit 40. One or more hollow fiber ceramic membranes modules 44-45 (see FIGS. 9-15) is housed in a generally U-shaped pipe section that includes two spaced apart vertical sections 93 connected by a one hundred eighty degree (180°) elbow 94. Modules 44-45 preferably are in conduits 39, 40 but have annular space around each module 44, 45 for collecting permeate water or for introducing backwash water. Conduits 39, 40 can be a part of six (6) vertical sections 93 of pipe each preferably housing a stack of three filtration modules 44 or 45. Two of the vertical sections 93 connect at a 180 degree elbow 94 (see FIGS. 16-21). Flow outlets 96 are provided on the conduits 39,40 and elbow sections 94 for permeate discharge and for retentate discharge. The permeate discharge flow outlets receive backwash water during a backwash cycle (see FIGS. 4 and 5). Each module 44-45 preferably has a plurality of hollow ceramic fibers membranes 46. FIGS. 9-15 show such modules 44-45 and ceramic fiber membranes 46 in more detail.

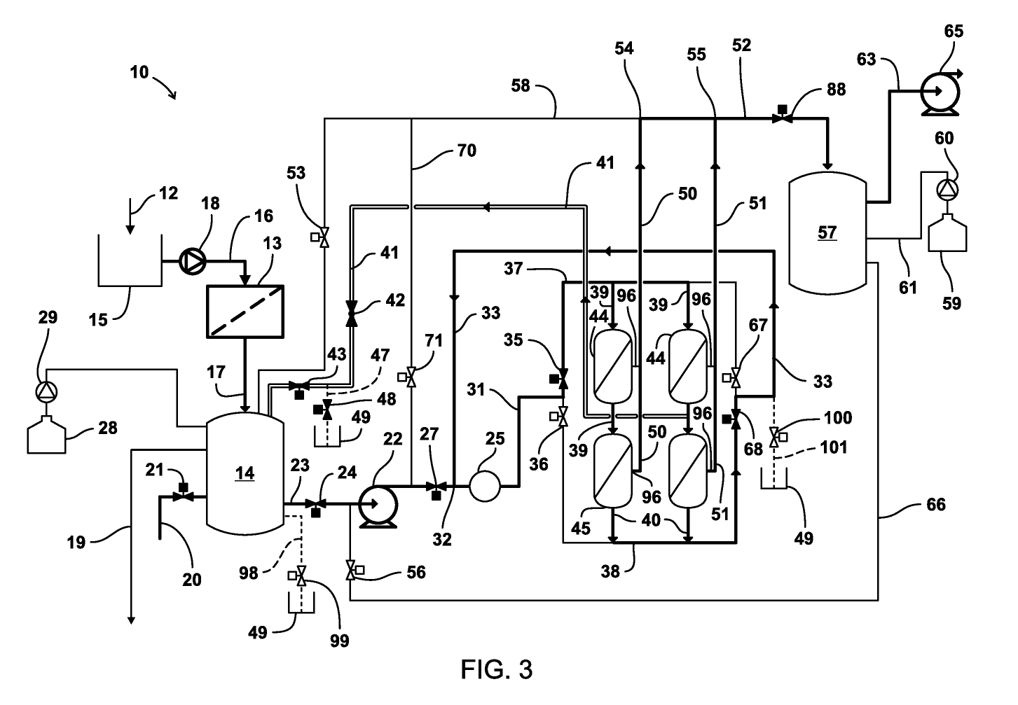

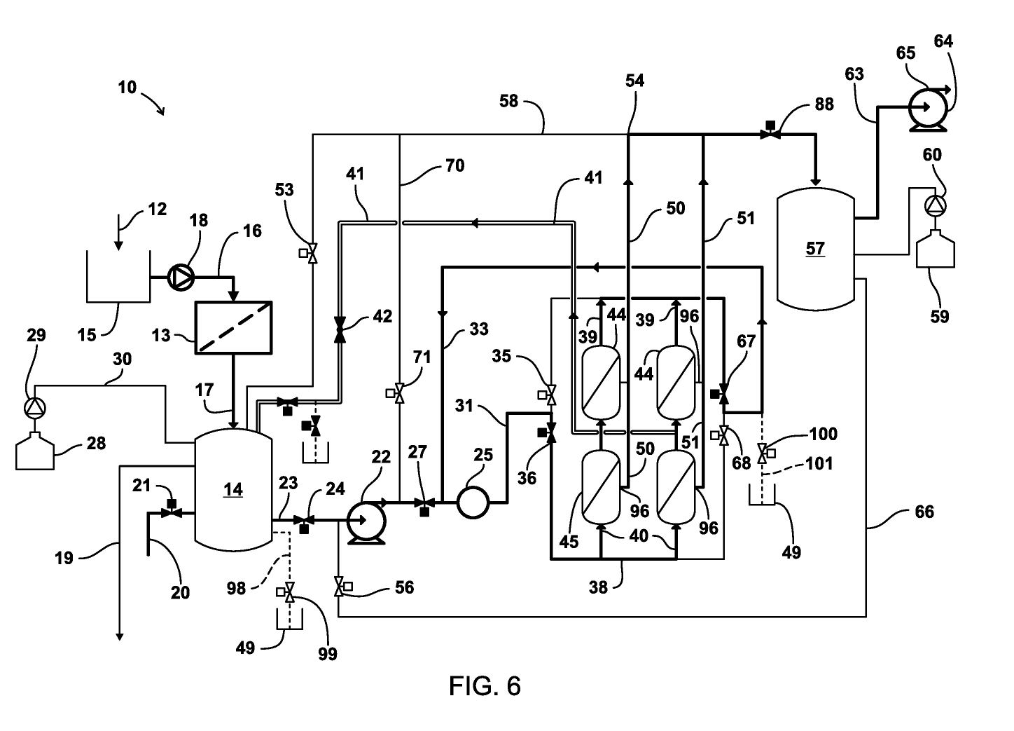

The method of the present invention intermittently alternates fluid to a left hand side membrane loop conduit 39 then to the right hand side membrane loop conduit 40 via a 180 degree elbow 94. In between the left hand conduit filtration (see FIG. 3) and the right hand conduit filtration (see FIG. 6) is a backwash cycle (see FIGS. 4-5).

In one embodiment, the method includes heating the wastewater stream or effluent held in a feed tank 14 by way of a valve 21 (e.g., actuated control valve) and heater or steam injector line 20. Feed tank 14 can have a level control and overflow line 19. Steam or heater 20 may be operable to heat the wastewater or effluent in tank 14 to about 40 degrees centigrade or more. The heater 20 may be operable to heat the effluent to about 50 degrees centigrade or more. The heater 20 may be operable to heat the effluent to within a temperature range of about 50 to 80 degrees centigrade. The heater 20 may be operable to heat the effluent to about 60 degrees centigrade or more.

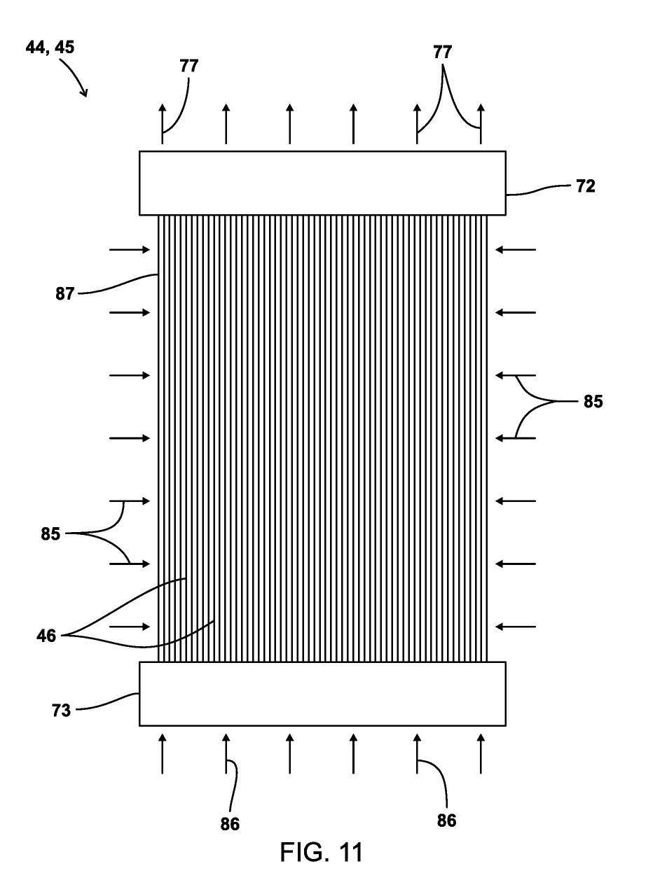

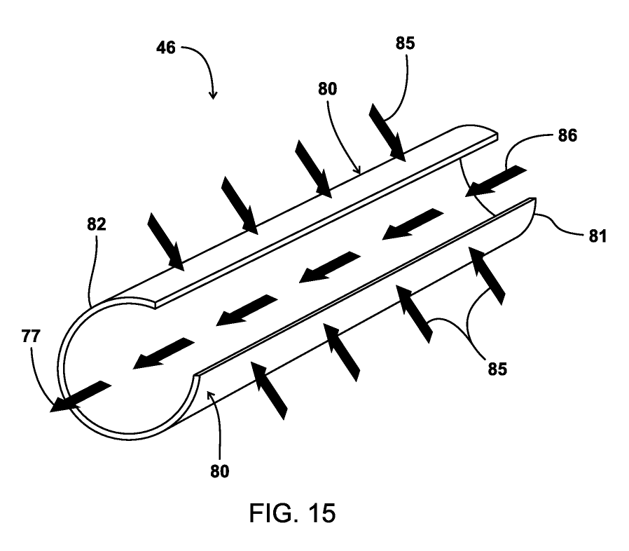

Once effluent 12 is at a temperature of between about 50 and 80 degrees centigrade, the feed pump 22 is enabled to a set point of between about 1-10 bar. Pump 22 receives flow from feed tank 14 via line 23 with valve 24. Pump 22 pumps to line 26 which is an inlet conduit. From pump 22, flow goes to pump 25 (circulation pump) and through valve 35 or 36 to the filtration modules 44 or 45. There are two (left and right) conduits 39, 40 each with multiple modules 44 or 45. Each module 44 or 45 is preferably contained in a stainless steel conduit or pipe 39 or 40 that enables filtered water to be collected after filtration through each hollow fiber ceramic membrane 46. The stainless steel conduit or pipe 39, 40 also preferably contains fluid used for backwash in an out to in flow path (seen in FIGS. 11 and 15).

In FIGS. 1-21 there are preferably eighteen (18) modules including nine (9) left side modules 44 and nine (9) right side modules 45. The membrane modules 44, 45 can be individual or stacked forming a vertical or horizontal column 93. A circulation loop conduit (lines 37, 39, 40, 38) feeds the hollow fiber ceramic membrane modules 44, 45. During this method, “crossflow” occurs at each hollow fiber membrane 46 in the module 44 or 45, separating contaminated effluent that is channeled to both the retentate conduit 41 and clean fluid conduits 50, 51, 52 known as permeate to the permeate clean tank 57.

Pump 22 supplies the wastewater 12 to circulation pump 25 via line 26 and valve 27. Tee fitting 32 connects line 26 and 33. Pump 25 discharges into line 31 and tee fitting 34 which provides selective transmission of fluid to either line 37 or 38 depending upon the open or closed state of valves 35, 36.

A circulation is enabled during filtration by transmitting the wastewater 12 in a first direction through lines 39, 40 and modules 44, 45 and back to circulation pump 25 via flow line 33. FIG. 3 demonstrates such a “left conduit” filtration. Retentate line 41 connects to lines 39, 40 and continuously removes retentate that is filtered by the modules 44, 45.

Retentate line 41 enables transmission of retentate to feed tank 14 via valves 42, 43. Part of the retentate stream of line 41 can be discarded to drain or sewer 49 via drain line 47 and valve 48. Permeate flow lines 50, 51, 52 transmit cleaned fluid from modules 44, 45 to permeate tank 57. Line 52 has valve 88. Permeate lines 50, 51 connect to line 52 at tee fittings 54, 55. Permeate tank 57 can be used for backwashing (FIGS. 4-5). Line 66 is a backwash flow line having valve 56. Line 66 joins line 23 at tee fitting 69. Line 61 enables pH adjustment of permeate water in tank 57. pH adjustment device 59 enables a desired pH adjustment via line 61 and pump 60. Clean water can be transmitted to commercial laundry 11 via flow line 63, pump 64 and discharge line 65. Water can optionally be discharged from feed tank 14 via flow line 98 and valve 99 to sewer 49.

FIG. 3 is a schematic diagram of filtration with pumping of effluent into the left conduits 39. Valve 71 of backwash line 70 is closed. Valve 36 is closed. Valve 67 is closed. Valve 56 is closed. Recirculating flow is from pumps 22 and 25 to line 31, then to line 37 via open valve 35, then to left inlet conduits 39 and then through the modules 44, 45 to lines 40 and 38. Valve 68 is open enabling recirculation to circulation pump 25 via line 33 to tee fitting 32.

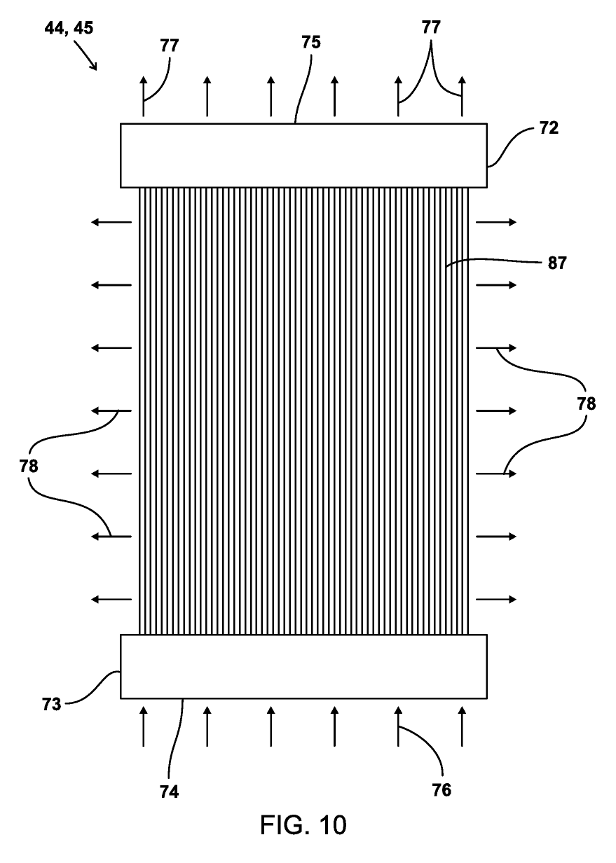

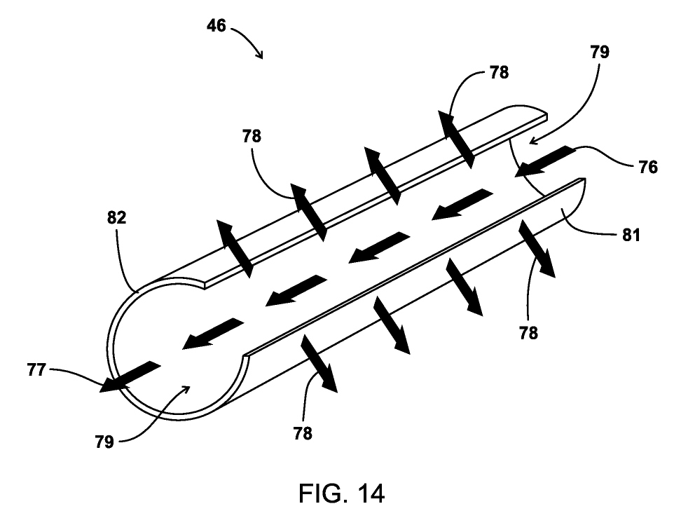

The filtration of FIG. 3 can operate for a time period of about 5 or more minutes. FIGS. 10 and 14 show filtration for a module 44 or 45 and for a single hollow fiber ceramic membrane 46. The backwash or backflush cycle then begins as seen in FIGS. 4-5.

FIGS. 9-15 illustrate filtration and backwash at modules 44, 45 and at each hollow fiber ceramic membrane 46. There are between about two hundred and fifteen hundred (200-1500) hollow fiber ceramic membranes 46 in each module 44, 45. These membranes 46 are bundled together to provide an overall cylindrically shaped bundle 87 of membranes 46 that are held in the cylindrically shaped bundle shape with end bands or end caps 72, 73. Flow of waste 12 enters each module (and thus each hollow fiber ceramic membrane 46) at one end 74, discharging at the other end 75. Arrows 76 designate entry of wastewater into each membrane 46 while arrows 77 represent the discharge of retentate from each module 44 or 45, as seen in FIG. 10. Arrows 78 represent the inside to outside flow of permeate (cleaner) water from membranes 46 inner channel 79 to outer surface 80 of each membrane 46 (see FIGS. 10 and 14).

Channels 79 of membranes 46 are open ended so that wastewater 12 enters channel 79 at a first end 81 then exits channel 79 at a second end 82. Membrane 46 can have a generally cylindrically shaped wall 84 surrounding channel 79. Wall 84 has inner surface 83 with a separating layer of porous polymeric material or porous ceramic material.

FIGS. 4-5, 11 and 15 illustrate a backwash which occurs after the filtration of FIG. 3. In FIG. 4, there is illustrated a flushing of fluid in a forward direction after the FIG. 3 filtration. Inlet conduits 23, 26 are flushed of commercial or industrial wastewater 12 using permeate from tank 57 or city water via flow line 66. Feed pump 22 and circulation pump 25 are activated for about 5-10 seconds. After about 5-10 seconds, the feed and circulation pumps 22, 25 are deactivated and all valves are moved to the positions of FIG. 5. The feed pump 22 is run at the same set point as for the FIG. 3 filtration but the circulation pump 25 is run at a lower frequency to create a pressure differential that enables the backwash flow shown in FIGS. 11 and 15. In FIG. 4, valves 24, 27, 35, 42, 43, 68 and 48 are open. Backwash line 66 valve 56 is open. Flow is from pumps 22, 25 via valves 24, 27 to line 31, then through valve 35 to lines 39, 40 then to line 38. Pump 25 is slowed so that flow in modules 44, 45 is from the outside to the inside of each hollow fiber ceramic membrane 46 as seen in FIGS. 11 and 15. Arrows 85 represent an outside to inside flow of fluid from outer surface 80 of each membrane 46 to the inside surface 83 and into the channel 79 as occurs during backwash. Simultaneously, flow through channel 79 is longitudinally from one end 81 to the other end 82 as illustrated by arrows 86 in FIG. 15. The flow longitudinally preferably carries away retentate that is adhered to inside surface 83 during the FIG. 3 filtration.

In FIG. 5, backwashed fluid exits modules 44, 45 via retentate line 41 and opened valves 42, 43. Retentate line 41 receives flow from conduits 39 and 40. Some of the retentate in line 41 can be dumped into sewer 49 via line 47 and valve 48. Backwash recirculating fluid travels from lines 66 to pump 22 to pump 25 to line 31 to lines 39, 40 then to line 38 and valve 68, then line 33 back to pump 25 as seen in FIG. 4. Backwash of FIGS. 4-5 is typically shorter in duration than the filtration cycle of FIG. 3. In FIGS. 11 and 15 pressure of water flowing through wall 84 (arrows 85, FIG. 15) is greater than the pressure of water flowing longitudinally in channel 79 as illustrated by arrows 86. Backwashing or back flushing includes the device inlet conduit being flushed of commercial or industrial effluent with fluid such as permeate or city water.

FIG. 6 shows filtration but with pumping of effluent into the right conduit. FIG. 6 is similar to FIG. 3, but valve 35 is closed and valve 36 is open so that flow through the modules 44, 45 is reverse when compared to the direction of flow in FIG. 3. In FIG. 6, valves 21, 24, 27, 36, 42 and 67 are opened. Valves 35, 68 and 53 are closed. Flow of waste 11 from tank 14 is via line 23 and valve 24 to pump 22 then via valve 27 to circulation pump 25, then line 31 to valve 36 to line 38 and then to inflow lines 40 and through modules 44, 45 to line 39 to valve 67 and line 33 to pump 25. This recirculation and filtration in FIG. 6 takes place for a filtration cycle of a selected time period.

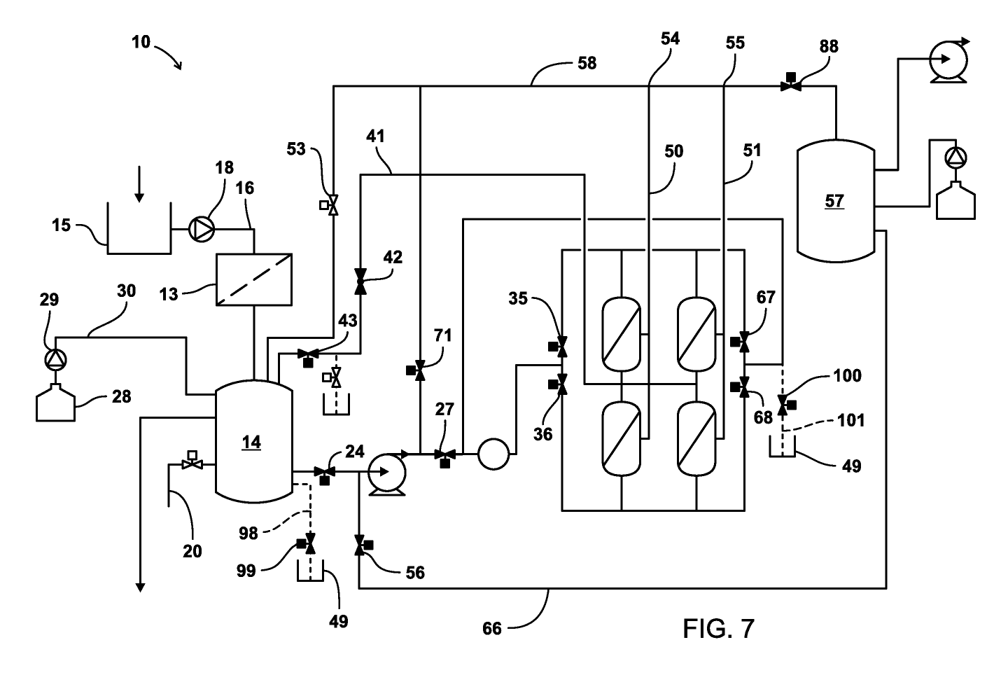

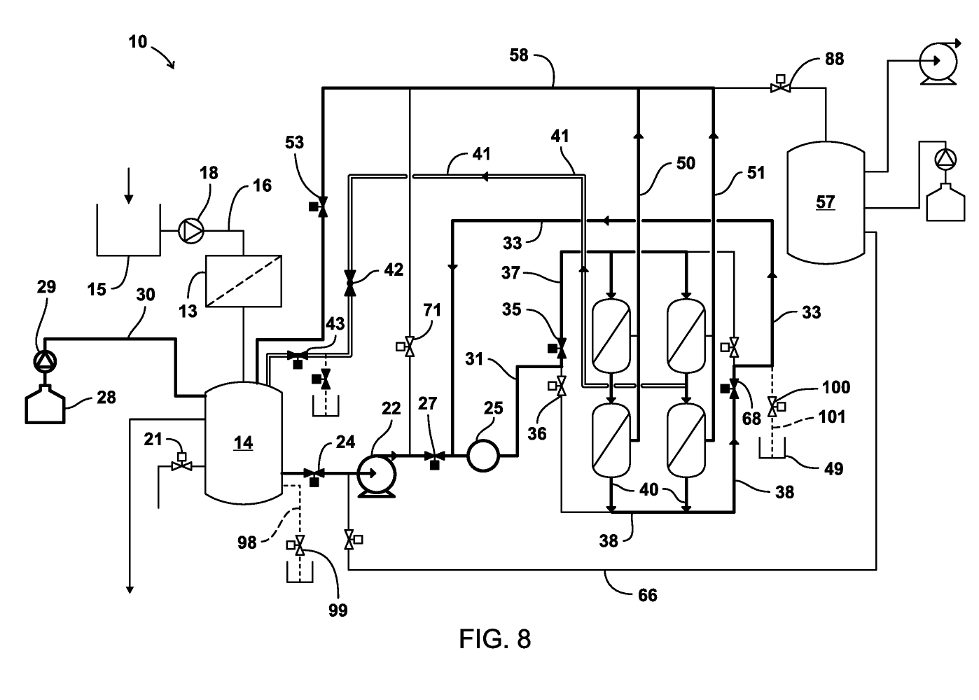

The present invention can optionally use cleaning in place. Cleaning in place can include the external injection from clean in place dosing tank 28 and pump 29 and via line 30 into the commercial or industrial laundry effluent treatment device of an alkali or acidic solution into the feed tank 14, mixed with clean water being city or permeate water. Clean in place is operable to preserve, maintain or restore the clean fluid permeation flow through the ceramic hollow fiber wall 84, being either individual or multiple hollow fiber membranes 46, which preferably includes nominal 220 to 1500 individual ceramic hollow fibers 46 preferably made of a substrate such as an aluminium oxide (Al₂O₃) substrate material. Selective pore sizes of the aluminium oxide substrate material (Al₂O₃) can be about 50 to 1400 nanometers, also but not limited to selective pore sizes of the aluminium oxide substrate material (Al₂O₃) being nominal 50 to 1400 nanometers, including nominal 1 to 100 nanometers ceramic or porous polymeric coating or multiple separate porous ceramic or polymeric coatings, acting as a separation layer attached to the membrane fiber wall at 83. In one embodiment, each hollow ceramic fiber 46 can have a polymeric or metal oxide or graphene oxide coating on the tube wall 84. In one embodiment, each hollow ceramic fiber can have a polymeric or metal oxide or graphene oxide coating on the tube wall. The metal oxide can preferably be, for example, aluminium oxide, zirconia oxide or titanium oxide. In FIGS. 7-8 clean in place device 28 transmits a selected cleaning chemical from the dosing device 28 and pump 29 to tank 14. Valves 24, 27, 35, 36, 42, 43, 56, 67, 68, 71 and 88 are opened. Valve 100 is opened to drain all fluid via line 101 to sewer 49. Line 98 and valve 99 can also be used to drain all fluid. Clean in place cycle can have a duration of about 60-1200 seconds. In FIG. 8, valves 24, 27, 35, 42, 43, 53 and 68 are open. Flow to valve 53 is via line 58.

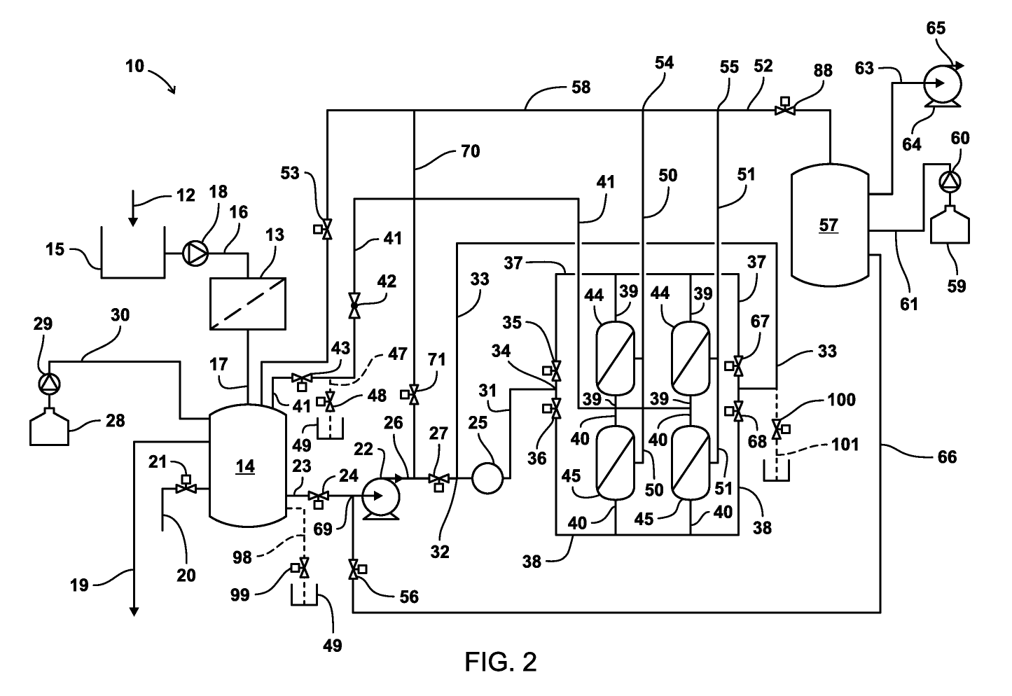

FIGS. 16-21 show an embodiment that employs a structural skid or base 62 to support components of the apparatus 10 of the present invention that are detailed in FIGS. 2-8. Skid or base 62 supports pumps 22, 25, stacks of modules 44, 45 and all valves (seen in FIGS. 2-8) downstream of effluent tank 14. Typically, skid 62 would not contain tank 14, screen 13, sump 15, or retentate tank 57. Skid or base 62 can contain a control panel 95 that would control operation of all pumps and valves. Retentate flow line 41 can be mounted in an elevated position above modules 44, 45. Permeate flow line 52 could be elevated as shown above modules 44, 45.

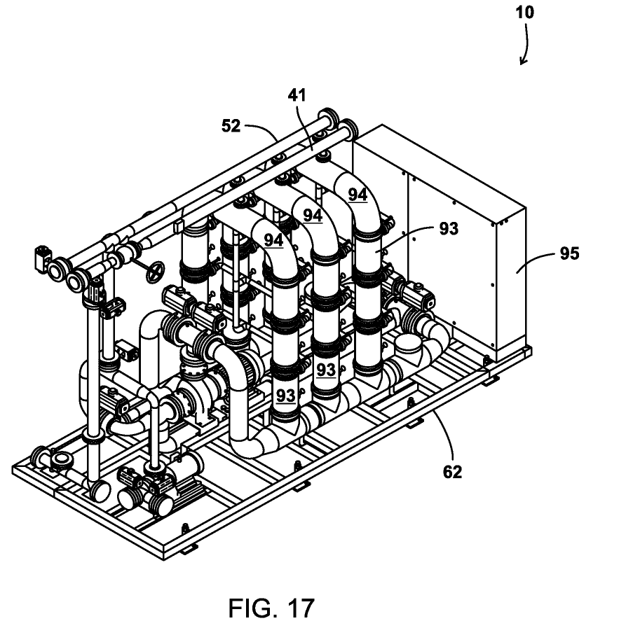

FIG. 16 shows a top view of a skid 62 that holds the pumps, valves and fittings of FIGS. 1-8 but typically not tanks 14, 15, 57 and screen 13. FIG. 17 is a perspective view showing the embodiment of FIG. 16.

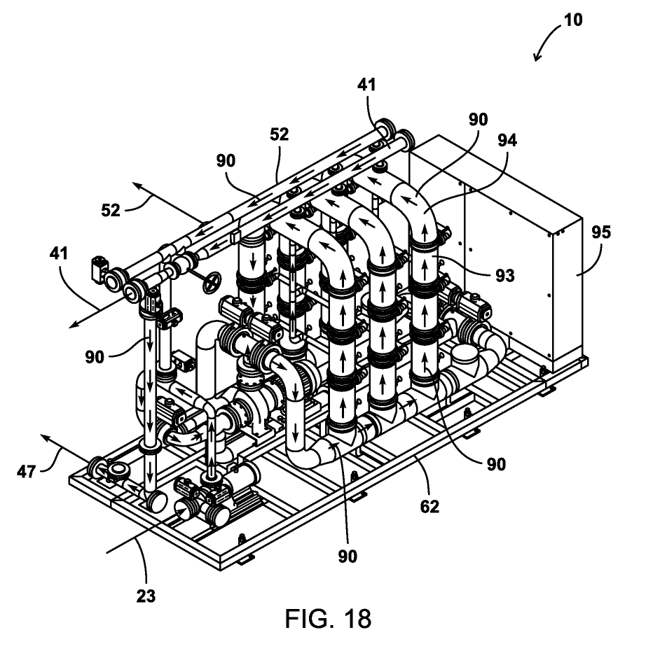

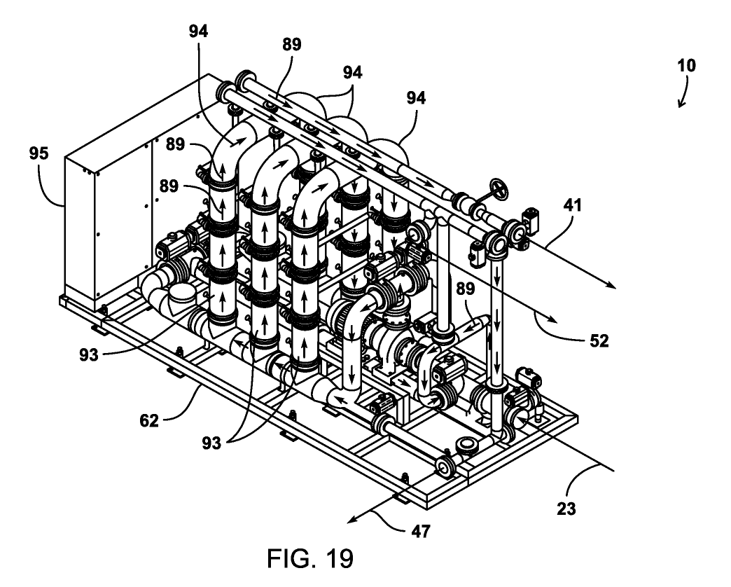

FIG. 18 shows right side filtration system with arrows 90 showing the path of fluid flow. FIG. 18 is a skid 62 mounted unit that corresponds to the flow diagram of FIG. 6. FIG. 19 shows a left filtration with arrows 89 showing the path of fluid flow. FIG. 19 is a skid 62 mounted unit that corresponds to FIG. 3.

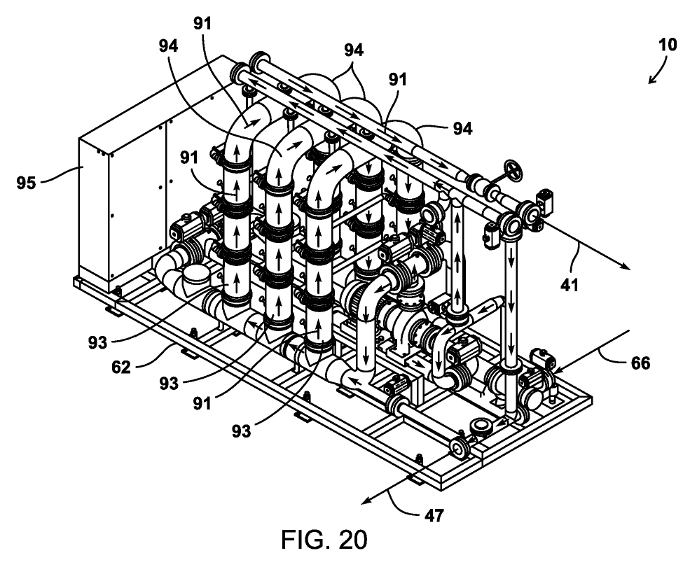

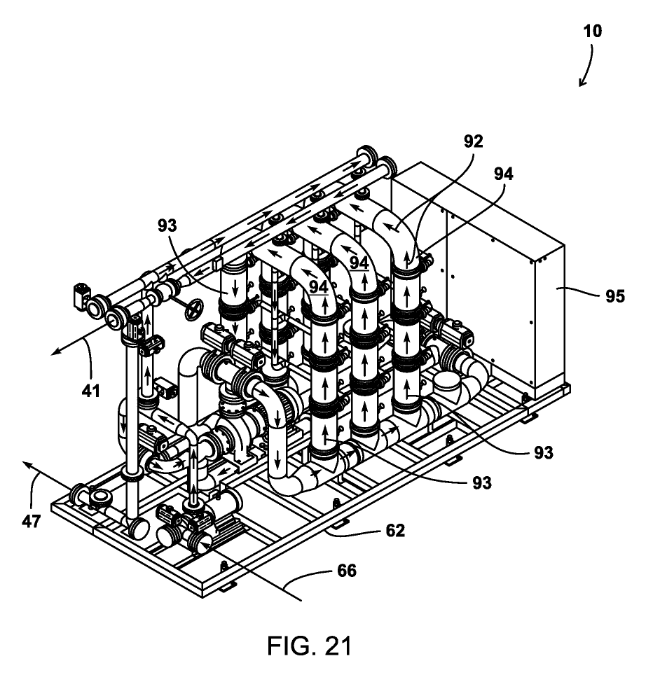

FIG. 20 shows backwashing left side wherein arrows 91 show the path of fluid flow. FIG. 21 shows backwashing right side wherein arrows 92 show the path of fluid flow. FIGS. 20 and 21 are skid mounted 62 versions.

The treatment equipment 10 shown in the drawings should be completely vented of air before filtration of FIG. 3 or 6. Trapped air within the associated skid conduits and membrane module or modules combined with the introduction of fluid flow and pressure could compromise the integrity and performance of the individual or bundled hollow fiber ceramic membrane fibers 46.

The following is a list of parts and materials suitable for use in the present invention:

### PARTS LIST

| PART NUMBER | DESCRIPTION |
|---|---|
| 10 | wastewater treatment apparatus |
| 11 | commercial laundry |
| 12 | commercial/industrial laundry effluent/wastewater |
| 13 | pretreatment screen/filter/vibrating screen |
| 14 | feed tank/vessel |
| 15 | sump/effluent sump |
| 16 | flow line |
| 17 | flow line |
| 18 | pump |
| 19 | overflow line |
| 20 | steam/steam inlet/steam flow line/heater |
| 21 | valve |
| 22 | feed pump |
| 23 | flow line |
| 24 | valve |
| 25 | circulation pump |
| 26 | flow line |
| 27 | valve |
| 28 | clean in place dosing device |
| 29 | pump |
| 30 | flow line |
| 31 | flow line |
| 32 | tee fitting |
| 33 | flow line |
| 34 | tee fitting |
| 35 | valve |
| 36 | valve |
| 37 | flow line |
| 38 | flow line |
| 39 | left conduit/membrane loop conduit |
| 40 | right conduit/membrane loop conduit |
| 41 | retentate line |
| 42 | valve |
| 43 | valve |
| 44 | module of ceramic hollow fiber membranes (left) |
| 45 | module of ceramic hollow fiber membranes (right) |
| 46 | hollow fiber ceramic membrane |
| 47 | drain line |
| 48 | valve |
| 49 | sewer |
| 50 | permeate flow line |
| 51 | permeate flow line |
| 52 | permeate flow line |
| 53 | valve |
| 54 | tee fitting |
| 55 | tee fitting |
| 56 | valve |
| 57 | clean water tank/permeate tank |
| 58 | flow line |
| 59 | pH adjustment device |
| 60 | pump |
| 61 | flow line |
| 62 | skid mounted treatment unit |
| 63 | flow line |
| 64 | permeate pump |
| 65 | flow line |
| 66 | backwash flow line |
| 67 | valve |
| 68 | valve |
| 69 | tee fitting |
| 70 | flow line |
| 71 | valve |
| 72 | band/cap |
| 73 | band/cap |
| 74 | end portion/end |
| 75 | end portion/end |
| 76 | arrow |
| 77 | arrow |
| 78 | arrow |
| 79 | channel |
| 80 | outer surface |
| 81 | end |
| 82 | end |
| 83 | inner surface |
| 84 | wall |
| 85 | arrow |
| 86 | arrow |
| 87 | bundle of fibers |
| 88 | valve |
| 89 | arrow |
| 90 | arrow |
| 91 | arrow |
| 92 | arrow |
| 93 | vertical section |
| 94 | 180 degree elbow |
| 95 | control panel |
| 96 | flow outlet |
| 98 | line |
| 99 | valve |
| 100 | valve |
| 101 | flow line |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of removing waste from a laundry wastewater stream, comprising the steps of:
a) heating the wastewater stream to a temperature of at least 40° Celsius;
b) transmitting the waste stream with piping to one or more modules, each module having multiple hollow ceramic fibers, each hollow ceramic fiber having a wall with an exterior and a bore;
c) filtering the waste stream to remove waste material from the waste stream by flowing the waste stream from the bore laterally through the wall to the exterior of the wall;
d) collecting a permeate fluid stream in step “c” of cleaned water that has passed through the walls of the hollow ceramic fibers;
e) after a time interval, backwashing each hollow ceramic fiber by flowing a backwash fluid from the exterior of the wall, through the wall and into the bore of each hollow ceramic fiber;
f) wherein in step “e” the backwash fluid is cleaner than the wastewater stream;
g) wherein in step “e”, a fluid stream flows longitudinally through the bore of each hollow ceramic fiber and simultaneously with backwashing to generate a retentate stream; and
h) transmitting the retentate stream to a collection vessel.

2. The method of claim 1 wherein in step “a” the temperature is between about 40-90 degrees Celsius.

3. The method of claim 1 wherein in step “f” the backwash fluid is permeate fluid that was collected in step “d”.

4. The method of claim 1 wherein in step “f” the backwash fluid includes clean water.

5. The method of claim 1 wherein the wall of each hollow ceramic fiber is between about 1 and 4 mm thick.

6. The method of claim 1 wherein in step “b” there are multiple of said one or more modules of hollow ceramic fibers in step “b”.

7. The method of claim 1 wherein in step “b” each hollow ceramic fiber has a separating layer with a pore size of between 1 and 1400 nanometers.

8. The method of claim 1 wherein in step “b” there are between about 200 and 1500 of said hollow ceramic fibers in each said module.

9. The method of claim 1 wherein the removed material in step “c” includes suspended and dissolved solids.

10. The method of claim 1 wherein the removed material in step “c” includes dye.

11. The method of claim 1 wherein the removed material in step “c” includes dissolved organics.

12. The method of claim 1 wherein the removed material in step “c” includes bacteria and viruses.

13. The method of claim 1 wherein the removed material in step “c” includes colloids.

14. The method of claim 6 wherein the multiple modules are stacked and aligned in series.

15. The method of claim 1 wherein the waste stream flows at a rate of between 10 and 500 gallons (38-1,893 liters) per minute.

16. The method of claim 1 wherein the permeate fluid stream is transmitted to a washing machine after step “d” at a temperature of at least 35 degrees Celsius.

17. The method of claim 1 wherein each hollow ceramic fiber in step “b” has an outside diameter of between about 4 and 6 mm.

18. The method of claim 1 wherein each hollow ceramic fiber in step “b” has a length of between about 300 and 1000 mm.

19. The method of claim 1 wherein in step “b” each hollow ceramic fiber includes a ceramic substrate with a pore size of between about 50 and 1400 nanometers.

20. The method of claim 1 wherein in step “b” each hollow ceramic fiber has a polymeric or metal oxide or graphene oxide coating on the tube wall.

21. The method of claim 1 wherein the filtration of step “c” has a duration of between about 5 and 120 minutes.

22. The method of claim 1 wherein the backwashing of step “e” has a duration of between about 10 and 60 seconds.

23. The method of claim 1 further comprising venting the piping and module or modules to reduce the risk of trapped air before the filtration of step “c”.

24. The method of claim 14 wherein there are multiple loops of stacks of modules.

25. The method of claim 1 wherein the filtration of step “c” includes transmitting the waste stream through the modules in a first flow direction and after the backwashing of step “e” transmitting the waste stream through the modules in a second flow direction that is opposite the first flow direction.

26. Laundry wastewater treatment apparatus comprising:
a) a piping system having an inflow for receiving a wastewater stream to be treated;
b) a heater for enabling heating of the wastewater stream to a temperature of at least 40° Celsius;
c) the piping including one or more modules, each module having multiple hollow ceramic fibers, each hollow ceramic fiber having a wall with an exterior and a bore;
d) one or more pumps that pump the wastewater stream to the module or modules and laterally through the wall to the exterior of the wall of each hollow ceramic fiber;
e) the piping system including a permeate fluid stream of cleaned water that has passed through the walls of the hollow ceramic fibers;
f) the piping system having valving that enables a backwashing each hollow ceramic fiber by flowing a backwash fluid with the pump or pumps from the exterior of the wall, through the wall and into the bore of each hollow ceramic fiber;
g) wherein the backwash fluid is cleaner than the wastewater stream;
h) wherein the pump or pumps transmit a fluid stream that flows longitudinally through the bore of each hollow ceramic fiber and simultaneously with backwashing to generate a retentate stream; and
i) a retentate stream collection vessel that receives retentate from the modules.

27. The treatment apparatus of claim 26 wherein the temperature of the wastewater stream is between about 40-90 degrees Celsius.

28. The treatment apparatus of claim 26 wherein backwash fluid is from the permeate fluid that was collected in step “d”.

29. The treatment apparatus of claim 26 wherein the backwash fluid includes clean water.

30. The treatment apparatus of claim 26 wherein the wall of each hollow ceramic fiber is between about 2 and 4 mm thick.

31. The treatment apparatus of claim 26 wherein there are multiple of said one or more modules of hollow ceramic fibers.

32. The treatment apparatus of claim 26 wherein each hollow ceramic fiber has a porous polymeric separating layer with a pore size of between 1 and 1400 nanometers.

33. The treatment apparatus of claim 26 wherein there are between about 200 and 1500 of said hollow ceramic fibers in each said module.

34. The treatment apparatus of claim 26 wherein the retentate includes suspended and dissolved solids.

35. The treatment apparatus of claim 26 wherein the retentate includes dye.

36. The treatment apparatus of claim 26 wherein the retentate includes dissolved organics.

37. The treatment apparatus of claim 26 wherein the retentate includes bacteria and viruses.

38. The treatment apparatus of claim 26 wherein the retentate includes colloids.

39. The treatment apparatus of claim 31 wherein the multiple modules are stacked and aligned in series.

40. The treatment apparatus of claim 26 wherein the wastewater stream flows at a rate of between 10 and 500 gallons (38-1,893 liters) per minute.

41. The treatment apparatus of claim 26 further comprising a washing machine and wherein the permeate fluid stream flows to the washing machine with a flow line at a temperature of at least 35 degrees Celsius.

42. The treatment apparatus of claim 26 wherein each hollow ceramic fiber has an outside diameter of between about 4 and 6 mm.

43. The treatment apparatus of claim 26 wherein each hollow ceramic fiber has a length of between about 300 and 1000 mm.

44. The treatment apparatus of claim 26 wherein each hollow ceramic fiber includes a ceramic substrate with a pore size of between about 50 and 1400 nanometers.

45. The treatment apparatus of claim 26 wherein each hollow ceramic fiber has a porous polymeric coating on the hollow ceramic fiber wall.

46. The treatment apparatus of claim 26 wherein there are multiple loops of stacks of modules.

47. The treatment apparatus of claim 26 further comprising a skid or base and wherein all or part of the piping system is mounted on the skid or base.

48. The treatment apparatus of claim 26 further comprising a skid or base and wherein all or part of the pumps is mounted on the skid or base.

49. The treatment apparatus of claim 26 further comprising a skid or base and wherein all or part of the modules is mounted on the skid or base.

50. The treatment apparatus of claim 47 wherein the piping system includes permeate and retentate flow lines supported upon the skid or base.

51. (canceled)
